(19) United States
(12) Patent Application Publication
(10) Pub. No.: US 2019/0210469 A1
(43) Pub. Date: Jul. 11, 2019

(54) COOLING APPARATUS FOR BATTERY

(71) Applicants: Hyundai Motor Company, Seoul (KR); Kia Motors Corporation, Seoul (KR)

(72) Inventor: Seung Woo YANG, Goyang-si (KR)

(73) Assignees: Hyundai Motor Company, Seoul (KR); Kia Motors Corporation, Seoul (KR)

(21) Appl. No.: 15/964,565

(22) Filed: Apr. 27, 2018

(30) Foreign Application Priority Data
Jan. 8, 2018 (KR) 10-2018-0002342

(51) Int. Cl. B60L 11/18; H01M 10/625; H01M 10/613; H01M 10/6556; C08K 7/14; C08L 67/06

(52) U.S. Cl. CPC B60L 11/1874; H01M 10/625; C08L 67/06; H01M 10/6556; C08K 7/14; H01M 10/613

(57) ABSTRACT

A cooling apparatus for a battery may include a battery module provided in a casing of metal while being in contact with an inner surface of the casing; a cooling block made of a resin material, and attached to an outer surface of the casing at a location facing a portion with which the battery module is in contact; and a cooling passage provided in the cooling block to allow a coolant to flow therethrough.

### CROSS REFERENCE TO RELATED APPLICATION

The present application claims priority to Korean Patent Application No. 10-2018-0002342, filed Jan. 8, 2018, the entire contents of which is incorporated herein for all purposes by this reference.

### BACKGROUND OF THE INVENTION

### Field of the Invention

The present invention relates to a cooling apparatus for a battery, in which cooling performance of a battery module is enhanced by improving a structure of a cooling block.

### Description of Related Art

A high-voltage battery is used to supply electrical energy for driving an electric vehicle, a fuel cell vehicle, or a hybrid vehicle.

The high-voltage battery includes a battery pack which is configured for generating high voltage by connecting multiple device cells or modules, generating high power using the battery pack.

In other words, the energy stored in the high-voltage battery is transmitted to the motor through the inverter to be used for starting, accelerating, a high-efficiency point operation of an engine, and the like, and when surplus energy is generated from the engine, the motor is used as a generator and the surplus energy is stored in the high-voltage battery.

Since the high-voltage battery has a considerable amount of current used and therefore a lot of heat is generated thereinside, a vehicle with high-voltage battery is provided with a cooling system for cooling the high-voltage battery.

In particular, recently, as a driving distance of a vehicle using a driving force of a motor becomes longer, a battery system is required to be upgraded gradually, and accordingly, an issue of enhancing the cooling performance of the battery system is further highlighted.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a cooling apparatus configured for a battery, in which cooling performance of a battery module is enhanced by improving a structure of a cooling block.

According to various aspects of the present invention, there is provided a cooling apparatus configured for a battery, the cooling apparatus including: a battery module provided in a casing of metal while being in contact with an internal surface of the casing; a cooling block including a resin material, and attached to an external surface of the casing at a location facing a portion with which the battery module is in contact; and a cooling passage provided in the cooling block to allow a coolant to flow therethrough.

The battery module may be bonded to the internal surface of the casing by a thermal interface material.

The cooling block may be manufactured by impregnating glass fiber with an unsaturated polyester resin.

The casing of metal and the cooling block of resin may be bonded together by a structural adhesive configured for bonding different materials.

The cooling passage may be provided to be in contact with the external surface of the casing of metal.

The cooling passage may be provided along a longitudinal direction in which the battery module is disposed.

A cover portion may protrude from the casing in a shape that surrounds side portions of the cooling block.

According to an exemplary embodiment of the present invention, since the cooling passage 7 is integrally formed in the cooling block 5, thereby simplifying the structure of the cooling block, it is possible to increase price competitiveness of the product by improving the ease of assembly. Furthermore, since the heat generated from the battery module is cooled by the coolant, and the heat transmitted from outside the casing is blocked from being transferred to the coolant by the cooling block having the heat-shielding function, it is possible to further enhance the cooling performance of the battery module.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view exemplarily showing a structure of a cooling apparatus configured for a battery according to an exemplary embodiment of the present invention; and

FIG. 2 is a view conceptually showing a structure of a cooling block according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present invention, it will be understood that the present description is not intended to limit the invention(s) to those exemplary embodiments. On the contrary, the invention(s) is/are intended to cover not only the exemplary embodiments of the present invention, but also various alternatives, modifications, equivalents and other embodiments, which may be included within the spirit and scope of the invention as defined by the appended claims.

Hereinbelow, an exemplary embodiment of the present invention will be described in more detail with reference to the accompanying drawings.

A cooling apparatus configured for a battery of the present invention may include a battery module 3, a cooling block 5, and a cooling passage 7.

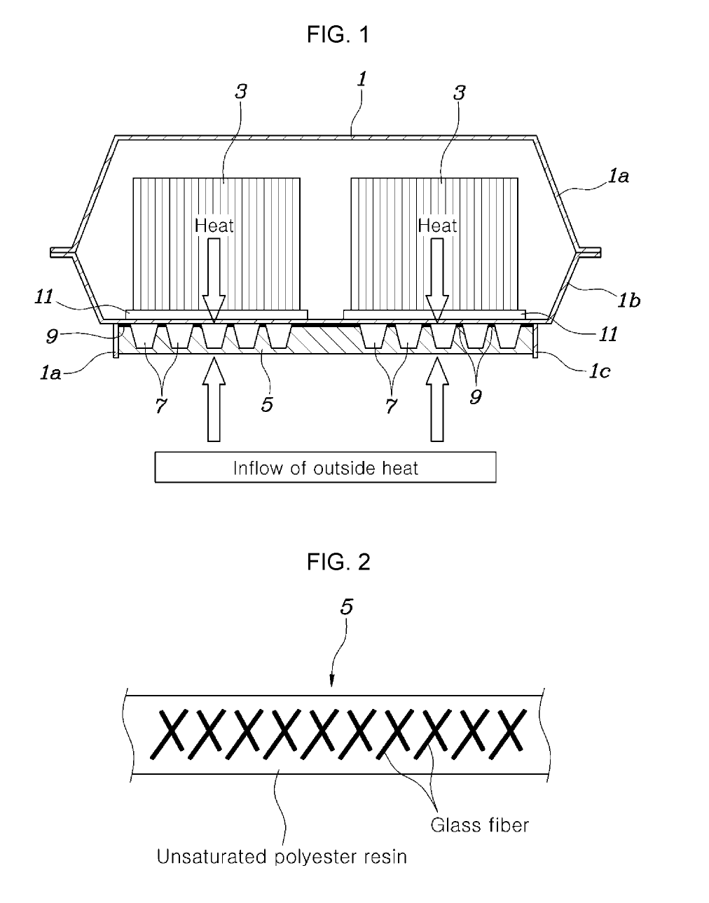

To be more specific to the present invention with reference to FIG. 1, firstly, the battery module 3 may be provided in a casing 1 of metal while being in contact with an internal surface of the casing.

For example, the casing 1 may be made of aluminum, and may be configured such that an upper casing 1a covers a lower casing 1b to define an internal space therein, wherein the battery module 3 is provided in the space.

The cooling block 5 may be made of a resin material having a heat-shielding function, and may be attached to an external surface of the casing 1 at a location facing a portion with which the battery module 3 is in contact.

For example, when the battery module 3 is attached to a bottom surface of the lower casing 1b, the cooling block 5 may be attached to a lower surface of the lower casing 1b.

The cooling passage 7 is provided in the cooling block 5 such that a coolant flows therethrough.

In other words, conventionally, the cooling block 5 may include two parts, i.e. upper and lower parts, to form a cooling passage thereinside through brazing the two parts, but in an exemplary embodiment of the present invention, the cooling passage 7 is integrally formed in the cooling block 5, simplifying the structure of the cooling block 5, so it is possible to improve the ease of assembly and is possible to solve the problem of poor bonding.

Furthermore, since the heat generated from the battery module 3 is conducted and is cooled by the coolant, and the heat transmitted from outside the casing 1 is blocked from being transferred to the coolant by the cooling block 5 having the heat-shielding function, it is possible to improve the cooling performance of the battery module 3.

Furthermore, the cooling block 5 applied to the present invention may be manufactured by SMC (sheet molding compound) which is a thermosetting composite molding material, wherein as shown in FIG. 2, the SMC may be manufactured by impregnating glass fiber with an unsaturated polyester resin to be in a sheet shape having a thickness of about 1 to 3 mm.

The SMC may be prepared by mixing the unsaturated polyester resin, the glass fiber, a mineral filler, and an additive such as a hardener, a thickener, a releasing agent, etc., and the SMC may include 20 o to 40% by weight of a resin.

The SMC has a high degree of freedom in being molded into products, making it easy to make large-sized products compared to thermoplastic resin materials, and compared to metallic materials, has the advantage of being easily molded into products with complex structures.

Furthermore, since the process may be unified, the cost of equipment is lower than that of steel, which saves costs in a flexible manufacturing system, it is possible to increase price competitiveness of the product.

along with excellent heat resistance, the SMC has a similar thermal expansion coefficient to steel, and has excellent impact resilience, corrosion resistance, adhesiveness, and paintability, enhancing product quality.

Meanwhile, the battery module 3 of the present invention may be bonded to the internal surface of the casing 1 by a thermal interface material 9.

In other words, the battery module 3 is allowed to be cooled more effectively by applying and bonding the thermal interface material 9 with high thermal conductivity between the battery module 3 from which the heat is generated and the casing 1 which is configured to conduct and discharge heat to the coolant side thereof.

Furthermore, in an exemplary embodiment of the present invention, the casing 1 of metal and the cooling block 5 of resin may be bonded together by a structural adhesive 11 that can bond different materials.

In other words, the lower casing 1b of metal and the cooling block 5 of resin may be boned together by use of the structural adhesive 11.

Furthermore, in an exemplary embodiment of the present invention, the cooling passage 7 may be configured to be in contact with the external surface of the casing 1 of metal. Furthermore, the cooling passage 7 may be provided along a longitudinal direction in which the battery module 3 is disposed.

In other words, since the cooling passage 7 with the coolant flowing therethrough is directly disposed on the external surface of the casing 1, the heat of the battery module 3 conducted to the casing 1 is dissipated more effectively, enhancing the cooling performance of the battery module 3, and since the cooling passage 7 is provided along the longitudinal direction in which the battery module 3 is disposed, the heat dissipation area of the battery module 3 is increased to further improve the cooling performance of the battery module 3.

Furthermore, a cover portion 1c may protrude from the casing 1 in a shape that surrounds side portions of the cooling block 5.

For example, since the cover portion 1c protrudes below the lower casing 1b and is fixed to the side surface of the cooling block 5, the cooling block 5 may be stably coupled to the casing 1.

In an exemplary embodiment of the presently claimed invention, the thickness of cover portion 1c is larger than the thickens of the cooling block 5.

The shape of cooling passage 7 is in an inverse-trapezoid such that upper portion of the cooling passage 7 facing a portion with which the battery module 3 is in contact is larger than the lower portion of the cooling passage 7.

As described above, since in various aspects of the present invention, the cooling passage 7 is integrally formed in the cooling block 5, simplifying the structure of the cooling block, it is possible to increase price competitiveness of the product by improving the ease of assembly.

Furthermore, since the heat generated from the battery module 3 is cooled by the coolant, and the heat transmitted from outside the casing 1 is blocked from being transferred to the coolant by the cooling block 5 having the heat-shielding function, it is possible to enhance the cooling performance of the battery module 3.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A cooling apparatus for a battery, the cooling apparatus comprising:
a battery module provided in a casing of metal while being in contact with an internal surface of the casing;
a cooling block including a resin material, and attached to an external surface of the casing at a location facing a portion with which the battery module is in contact; and
a cooling passage provided in the cooling block to allow a coolant to flow therethrough.

2. The cooling apparatus of claim 1, wherein the casing is made up of metal.

3. The cooling apparatus of claim 1, wherein the battery module is bonded to the internal surface of the casing by a thermal interface material.

4. The cooling apparatus of claim 1, wherein the cooling block is manufactured by impregnating glass fiber with an unsaturated polyester resin.

5. The cooling apparatus of claim 1, wherein the casing and the cooling block of resin are bonded together by a structural adhesive configured for bonding different materials.

6. The cooling apparatus of claim 1, wherein the cooling passage is provided to be in contact with the external surface of the casing.

7. The cooling apparatus of claim 1, wherein the cooling passage is provided along a longitudinal direction in which the battery module is disposed.

8. The cooling apparatus of claim 1, wherein a cover portion is protrudingly formed from the casing in a shape that surrounds side portions of the cooling block.

9. The cooling apparatus of claim 7, wherein a thickness of the cover portion is larger than a thickens of the cooling block.

10. The cooling apparatus of claim 1, wherein the cooling passage is in an inverse-trapezoid and an upper portion of the cooling passage facing a portion with which the battery module is in contact is larger than a bottom portion of the cooling passage.
